(19) United States
(12) Patent Application Publication
(10) Pub. No.: US 2021/0276444 A1
(43) Pub. Date: Sep. 9, 2021

(54) METHOD AND DEVICE OF CHARGING SESSION MANAGEMENT

(71) Applicant: Alcatel Lucent, Nozay (FR)

(72) Inventors: Xiangyang Li, Shanghai (CN); Yigang Cai, Naperville, IL (US)

(73) Assignee: Alcatel Lucent, Nozay (FR)

(21) Appl. No.: 16/321,724

(22) PCT Filed: Aug. 3, 2017
(86) PCT No.: PCT/IB2017/001142

§ 371 Date: Jan. 29, 2019

(30) Foreign Application Priority Data
Aug. 4, 2016 (CN) 201610630850.9

(51) Int. Cl. B60L 53/63; B60L 53/68; B60L 53/66

(52) U.S. Cl. CPC B60L 53/63; B60L 53/68; B60L 2240/70; B60L 2240/80; B60L 53/66

(57) ABSTRACT

Embodiments of the present disclosure provide a method of charging session management. The method comprises, at a first node of a communication system, receiving an indication of charging termination associated with a terminal device from a second node of the communication system, where the indication of charging termination at least specifies a time length; detecting traffic for the terminal device in response to receiving the indication of charging termination; and in response to the traffic for the terminal device being lower than a predetermined threshold, starting a timer for terminating a charging session of the terminal device after the time length. Embodiments of the present disclosure further provide a corresponding device.

### FIELD

Embodiments of the present disclosure generally relate to the field of communications, and specifically to a method and device of charging session management.

### BACKGROUND

In a current LTE system based on a Policy Charging Control (PCC) mechanism, it is usually the case that a Packet data network Gateway (PGW) monitors and traces uplink and downlink data stream or other traffic for a terminal device, maintains the charging session, and interacts with an Online Charging System (OCS) and an Offline Charging System (OFCS) to perform the charging on the terminal device.

As mobile services and terminal applications develop, a communication connection session tends to last longer session duration. However, currently even if there are no useful charging activities, for example, the terminal device is in a sleep or idle state, such as night time period, the charging session still remains alive, sometimes even for several months. This is a great waste for network resources for performing charging monitoring, and thus there is a need to optimize the charging management procedure.

### SUMMARY

Generally, embodiments of the present disclosure provide a solution of managing charging session by using information on time on Radio Resource Control (RRC) connection release, to optimize Gy and Gz session control and charging procedure.

In a first aspect of the present disclosure, there is provided a method of charging session management. The method comprises: receiving, at a first node of a communication system, an indication of charging termination associated with a terminal device from a second node of the communication system, where the indication of charging termination at least specifies a time length; in response to receiving the indication of charging termination, detecting traffic for the terminal device; and in response to the traffic for the terminal device being lower than a predetermined threshold, starting a timer for terminating a charging session of the terminal device after the time length.

In some embodiments, receiving the indication of charging termination comprises: receiving an indication of releasing time of a Radio Resource Control (RRC) connection from the second node.

In some embodiments, the method further comprises: in response to the traffic of the terminal device being above the predetermined threshold, redetecting the traffic of the terminal device after a predetermined time interval; and in response to the traffic of the terminal device decreasing below the predetermined threshold, starting the timer for terminating the charging session of the terminal device after the time length.

In some embodiments, the method further comprises: in response to the timer having expired, originating a request of charging termination to a charging system of the communication system; receiving a response to the request of charging termination from the charging system; and terminating the charging session of the terminal device based on the response.

In some embodiments, the method further comprises: after the timer is started and before the timer expires, detecting a change in the traffic for the terminal device; and in response to detecting that the traffic for the terminal device increases above the predetermined threshold, stopping the timer.

In some embodiments, receiving the indication of charging termination comprises receiving at least one of a Create Session Request and a Modify Bearer Request.

In some embodiments, the time length is determined by a negotiation between the terminal device and a base station device in the communication system based on traffic of the terminal device.

In some embodiments, the first node is a packet data network gateway of the communication system, and the second node is a service gateway of the communication system.

In a second aspect of the present disclosure, there is provided a network device in a communication system. The network device comprises: a receiver configured to receive, from a node of the communication system, an indication of charging termination associated with a terminal device, the indication of charging termination at least specifying a time length; and a processor configured to: in response to receiving the indication of charging termination, detect traffic for the terminal device; and in response to the traffic for the terminal device being lower than a predetermined threshold, start a timer for terminating a charging session of the terminal device after the time length.

In some embodiments, the receiver is configured to receive from the node an indication of releasing time of a Radio Resource Control (RRC) connection.

In some embodiments, the processor is configured to: in response to the traffic of the terminal device being above the predetermined threshold, redetect the traffic of the terminal device after a predetermined time interval; and in response to the traffic of the terminal device decreasing below the predetermined threshold, start a timer for terminating the charging session of the terminal device after the time length.

In some embodiments, the processor is further configured to: in response to the timer having expired, originate a request of charging termination to a charging system of the communication system; and terminate the charging session of the terminal device based on a response to the request of charging termination from the charging system. The receiver is configured to receive the response to the request of charging termination from the charging system.

In some embodiments, the processor is further configured to: after the timer is started and before the timer expires, detect a change in the traffic for the terminal device; and in response to detecting that the traffic for the terminal device increases above the predetermined threshold, stop the timer.

In some embodiments, receiving the indication of charging termination comprises receiving at least one of a Create Session Request and a Modify Bearer Request.

In some embodiments, the time length is determined by a negotiation between the terminal device and a base station device in the communication system based on traffic of the terminal device.

In some embodiments, the network device is a packet data network gateway of the communication system, and the node is a service gateway of the communication system.

In a third aspect of the present disclosure, there is provided a computer readable storage medium. The computer readable storage medium has computer readable program instructions stored thereon for performing steps of the method according to the first aspect of the present disclosure.

The method and device according to embodiments of the present disclosure, with control of appropriate indications about RRC connection of the terminal device in the charging session management, enables termination of the charging session between the charging enforcement function entity (e.g., PGW) and the charging system (e.g, OCS/OFCS) at a proper time, and thus saving the monitoring and calculating demands of the network device, optimizing management of the charging session, and optimizing network resource utilization as well.

### BRIEF DESCRIPTION OF THE DRAWINGS

Through the following detailed description with reference to the accompanying drawings, the above and other features, advantages and aspects of example embodiments of the present disclosure will become more apparent. In the drawings, identical or similar reference numbers represent the same or similar elements, in which:

FIG. 1 illustrates a schematic diagram of a wireless communication system where embodiments of the present disclosure can be implemented;

FIG. 2 illustrates a schematic diagram of an interaction procedure of managing a charging session according to an embodiment of the present disclosure;

FIG. 3 illustrates a schematic diagram of a procedure where a timer in PGW is expired according to an embodiment of the present disclosure;

FIG. 4 illustrates a schematic diagram of an interaction procedure of managing a charging session according to another embodiment of the present disclosure;

FIG. 5 illustrates a schematic diagram of an interaction procedure of managing a charging session according to a further embodiment of the present disclosure;

FIG. 6 illustrates a flowchart of a method of managing a charging session according to an embodiment of the present disclosure;

FIG. 7 illustrates an applicable block diagram of an apparatus according to an embodiment of the present disclosure.

### DETAILED DESCRIPTION

Embodiments of the present disclosure are described now in detail in conjunction with the accompanying drawings. It should be noted that like parts or functional components may be denoted by the same reference numbers in the drawings. The drawings are only intended to illustrate exemplary embodiments of the present disclosure. Those skilled in the art, without departing from the spirit and protection scope of the present disclosure, may obtain alternative embodiments from the following description.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.”

The term “terminal device” used here refers to any terminal device capable of communicating with a base station. The terminal device may be either user equipment (UE) or any terminal having a wireless communication function, including but not limited to a mobile phone, personal computer, personal digital assistant, gaming machine, wearable device, sensor or the like. The term UE may be used interchangeable with mobile station, subscriber station, mobile terminal, user terminal or wireless device. The term “network device” refers to devices operating at a network side in a communication system, including but not limited to base station and various network nodes such as mobility management node and gateway node.

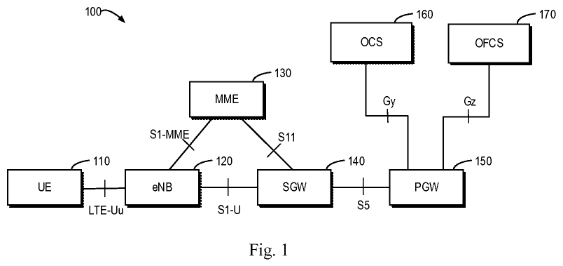

FIG. 1 illustrates a schematic block diagram of an example communication system 100 where embodiments of the present disclosure can be implemented. Those skilled in the art may understand that some function entities in the system are omitted to facilitate description without making the object of technical solutions of the present disclosure vague, and only an LTE-based system is taken as an example here.

Especially, to better illustrate the principle and spirit of the present disclosure, embodiments of the present disclosure will be described hereunder by mainly referring to 3GPP LTE/LTE-Advanced (LTE-A), and employing terms specific to LTE/LTE-A. However, those skilled in the art may understand that embodiments of the present disclosure are absolutely not limited to an application environment of 3GPP LTE/LTE-A, instead, they may be applied to a wireless communication system in which similar problems exist, for example, other communication systems to be developed in the future.

The illustrated communication system 100 comprises a UE 110, an Evolved node B (eNB) 120, a Mobility Management Entity (MME) 130, a Service Gateway (SGW) 140, a Packet data network Gateway (PGW) 150, an Online Charging System (OCS) 160 and an Offline Charging System (OFCS) 170. It may be appreciated that some network entities (e.g., SGW 140 and PGW 150) may be physically implemented in one physical node or individual nodes.

The UE 110 may access to the network through a radio access network such as Evolved UMTS Terrestrial Radio Access Network (E-UTRAN), and it communicates with a base station (e.g., eNB 120) via LTE-Uu to access the communication system 100 and use services provided. UE-related control signaling is processed by MME 130 via an interface S1-MME. The user's data traffic is processed by the SGW 140 and PGW 150, and the SGW 140 terminates the user plane to the access network. The PGW 150 interacts with OCS 160 and OFCS 170 respectively via Gy and Gz interfaces.

It should be noted that the communication network comprises Policy and Charging Enforcement Function (PCEF) and Traffic Detection Function (TDF), Charging Trigger Function (CTF) to perform detection of traffic data stream and application, policy enforcement and starting of the charging function of services or sessions. These function entities are usually arranged on the PGW. To facilitate description, as shown by the exemplary communication system 100 herein, these function entities are considered as being integral with the PWG 150. In addition, the interfaces and communication manners between the above network device/function entities have already been defined in detail in the current 3GPP protocols and thus will not be detailed herein.

In an LTE network, data flows are carried over Radio Resource Control (RRC) connection. When the UE 110 wants to transmit or receive data, the UE 110 sends a RRC Connection Request to the eNB 120 to establish a RRC connection to carry this data flow. After RRC establishment, the eNB 120 is reserved for a fixed time for possible sooner upcoming data event. When time is out, the RRC connection is released, and UE 110 enters the state of RRC connection idle, i.e., the UE is put in sleep mode. In the current LTE network design, the fixed time (or, a set timer) for the UE 110 to come to the sleep mode is configured by the core network. When UE 110 still has data to be transmitted, a new RRC connection needs to be re-established.

In addition, an RRC connection release mechanism initiated by the network is usually taken in LTE. The MME 130 sends a release connection message to the eNB 120, the eNB 120 then sends the RRC connection release message to the UE 110, thereby releasing the radio bearer and S1 bearer of the UE. However, since the PGW 150 does not know whether the UE 110 is in a connection state or an idle state, it usually maintains the Gy session active. Hence, even if when the UE 110 is in the idle state, PGW 150 still maintains the charging session for the UE 110, and constantly performs charging processing such as monitoring and various computations.

With terminal device, particularly smart phones, developed quickly, the terminal device, such as UE 110, now is able to predict the upcoming application event and therefore is able to notify the eNB 120 whether there is upcoming data event and thereby in turn to request eNB 120 for its own transmission demand. The demand may include an indication to extend or shorten the RRC connection time, and meanwhile the indication also reflects a communication state that the UE 110 will get into, namely an active state or sleep state. Such indication is advantageous, which considers the traffic demands of the UE 110 itself, rather than that the network side sets a fixed timer. This facilitates power supply management of the UE 110 as well as network side resource scheduling. In addition, on the basis of the current communication system, for example the communication system 100, extending the information to the PGW 150 by extending the signaling and enhancing the interface may perform more flexible management and control of charging session, and save the resources of network entities related to the charging.

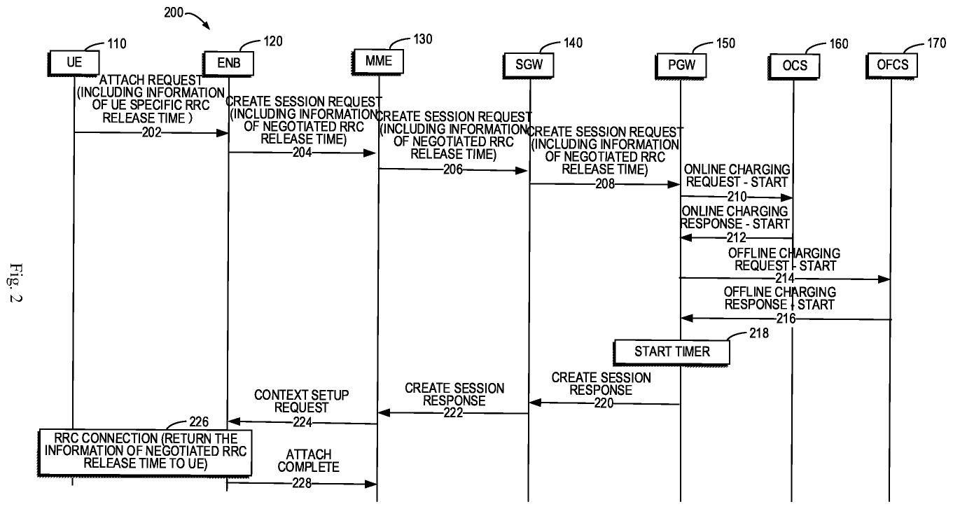

Based on the above understanding, the present disclosure aims to provide a solution of managing charging session by using information on time of RRC connection release, to optimize Gy and Gz session control and charging procedure. FIG. 2 to FIG. 5 illustrate schematic diagrams of interaction procedures of managing charging session according to several embodiments of the present disclosure.

FIG. 2 illustrates a procedure 200 of managing charging session according to an embodiment of the present disclosure. Herein, the communication system 100 is taken as an example to describe interaction of network entities. However, those skilled in the art may understand that the network entities here are only examples used to illustrate embodiments of the present disclosure and should not be considered as limitations of the present disclosure. Other current or to-be-developed devices should be included in the protection scope of the present disclosure if they may also implement solutions of the present disclosure.

The procedure 200 shows a procedure of attaching the UE 110 to the network. As mentioned above, the UE 110, according to prediction of its own application, includes its specific information about the RRC release timer in an Attach Request, and transmits (202) to the eNB 120. When the eNB 120 receives the Attach Request from the UE, eNB 120 knows whether the request is to extend or shorten the value of the RRC release timer. At this time, eNB 120 may accept the request, reject the request or negotiate the request based on the current state of the network resources, uplink and downlink data flow or traffic behavior of the UE 110 provided by MME 130, other policies or the like. In the present embodiment, the negotiated RRC release time (or timer) is taken as an example for illustration. The negotiated RRC release timer indicates that if the timer expires and there is no traffic of UE 110, for example, there is no uplink and downlink data flow, MME 130 or eNB 120 will mark UE 110 as sleep state. Also, those skilled in the art may understand that it is possible to include information on the RRC release timer in the message in any suitable manner, for example, by using an appropriate Information Element (IE).

Then, eNB 120 transmits (204) a Create Session Request including the information on the negotiated RRC release timer to MME 130 via a non-access stratum (NAS). The MME 130 receives the request and changes the RRC connection state of UE 110. MME 130 then forwards (206) the Create Session Request the Create Session Request including the information on the negotiated RRC release timer to SGW 140, SGW 140 then forwards (208) it to PGW 150. The procedure of transferring the information on the negotiated RRC release timer may be implemented by extending the current GTP-C interface.

Upon reception of the Create Session Request from SGW 140, PGW 150 transmits (210) an Online Charging Request-Start to OCS 160, and transmits (214) an Offline Charging Request-Start to OFCS 170. After receiving the Charging Responses-Start from the OCS 160 and OFCS 170, PGW 150 starts (218) the timer. A time length value of the timer is the value of the negotiated RRC release timer for UE 110 included in the received Create Session Request. Note that PGW 150 may monitor the downlink traffic of the UE 110. If the traffic is lower than a threshold, for example, there is no downlink data of the UE 110 or the downlink data amount is low enough, PGW 150 starts the timer.

Subsequently, PGW 150 transmits (220) a Create Session Response to SGW 140, and correspondingly, SGW 140 forwards (222) the Create Session Response to the MME 130. MME 130 transmits (224) a Context Setup Request to eNB 120 in response to the reception of the Create Session Response. Then, a RRC connection setup message is communicated between eNB 120 and UE 110, and the information on the negotiated RRC release timer is returned to the UE 110. The RRC connection is set up (226) between eNB 120 and UE 110. eNB 120 then transmits (228) Attach Complete to MME 130, whereby UE 110 completes the initial attach procedure.

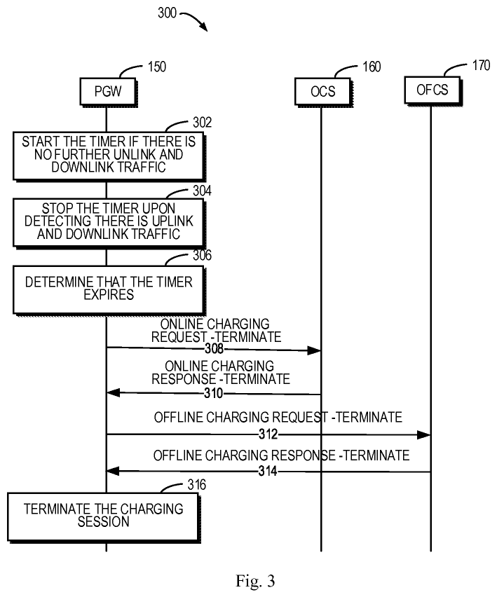

On the other hand, PGW 150 starts the timer after receiving the Charging Response-Start from OCS 160 and OFCS 170. When the timer expires, a charging session termination procedure for UE 110 will be triggered. The procedure may be performed as described below with reference to FIG. 3.

FIG. 3 illustrates a procedure 300 in which a timer in PGW corresponding to the RRC release timer expires according to an embodiment of the present disclosure. As stated above, PGW 150 monitors traffic (i.e., uplink and downlink data flow) of the terminal device, such as UE 110, and it performs charging processing based on the monitored data. If the traffic is lower than a threshold, for example, there is no further uplink and downlink traffic, PGW 150 starts (302) the timer. When it is determined (306) that the timer expires, PGW 150 presumes that there is no traffic to or from the UE 110, and transits (308) an Online Charging Request-Termination to OCS 160, and transmits (312) an Offline Charging Request-Termination to OFCS 170 respectively. In response to receiving responses from OCS 160 and OFCS 170, the charging session for UE 110 is terminated (316).

In an embodiment of the present disclosure, after PGW 150 starts the timer, if it is monitored that there is uplink and downlink traffic of the UE 110, the timer is stopped to cancel the timing operation. In another embodiment of the present disclosure, after PGW 150 starts the timer and before the timer expires, a change of uplink and downlink traffic for the UE 110 is detected. When it is detected that the traffic rises above a predetermined threshold, for example it is detected that there is uplink and downlink data flow of UE 110, the timer is stopped to cancel the timing operation.

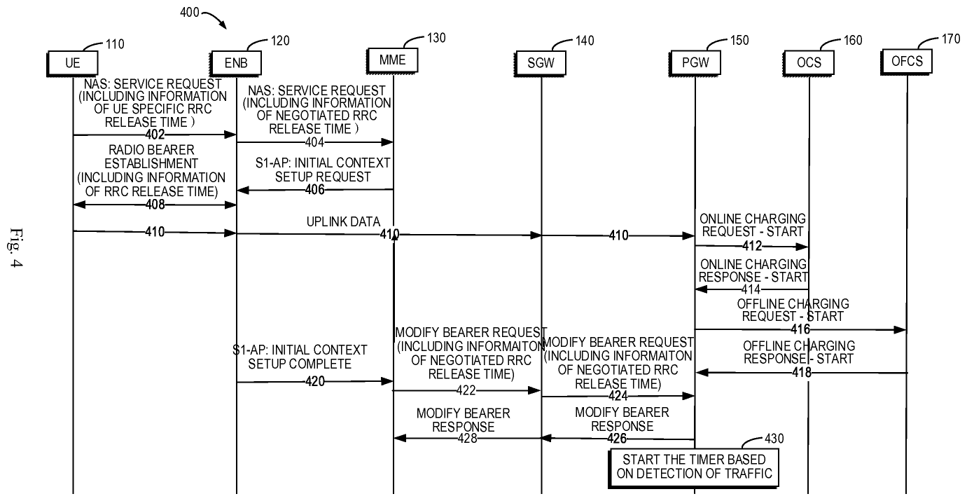

FIG. 4 illustrates a procedure 400 of managing charging session according to another embodiment of the present disclosure. The procedure 400 shows a scenario where a service request is triggered at UE 110. The user of UE 100 initiates uplink data to the network when UE 110 is in a sleep state.

First, UE 110 transmits (402) a service request (NAS message) to eNB 120. The service request may be encapsulated in a RRC message and includes information on its specific RRC release timer. As in the description of the procedure 200 in FIG. 2, UE 110, through the request, further indicates a need to extend or shorten the value of the RRC release timer. When eNB 120 receives the service request, it may accept the request, reject the request or negotiate the request. In the present embodiment, the negotiated RRC release timer is still taken as an example for illustration.

eNB 120 forwards (404) the service request including the information on the negotiated RRC release timer to MME 130. Upon reception of the service request, MME 130 transmits (406) an Initial Context Setup Request (S1-AP message) to eNB 120. Then, a Radio Bearer Establishment message is communicated between eNB 120 and UE 110, meanwhile the information on the negotiated RRC release timer is returned to UE 110, and a radio bearer is established (408) between eNB 120 and UE 110.

Then, UE 110 transmits (410) uplink data, and the uplink data is forwarded (410) by eNB 120, SGW 140 to PGW 150. When the uplink data of UE 110 is received from SGW 140, PGW 150 transmits (412) an Online Charging Request-Start to OCS 160 and transmits (416) an Offline Charging Request-Start to OFCS 170. Correspondingly, OCS 160 returns (414) an Online Charging Response-Start and OFCS 170 returns (418) an Offline Charging Response-Start to PGW 150.

As the radio bearer has already been established between UE 110 and eNB 120 at this time, eNB 120 may transmit (420) an Initial Context Setup Complete (S1-AP message) to MME 130. In response to receiving the message, MME 130 transmits (422) Modify Bearer Request including the information on the negotiated RRC release timer to SGW 140, and SGW 140 forwards (424) the Modify Bearer Request including the information on the negotiated RRC release timer to PGW 150. PGW 150 returns (426) Modify Bearer Response, and then SGW 140 forwards (428) the Modify Bearer Response to MME 130.

It will be appreciated that once the radio bearer is established, eNB 120 may feedback the Initial Context Setup Complete message to MME 130; meanwhile, once PGW 150 receives the uplink data, it triggers the charging session and starts a new Gy online charging session and a new Gz offline charging session. Hence, those skilled in the art may understand that the sequence of steps in method 400 is only illustrative, and there may exist a procedure of executing the steps simultaneously if appropriate.

On the other hand, PGW 150, in response to receiving the information on the negotiated RRC release timer, detects that the traffic to or from UE 110 is lower than a threshold, for example, there is no uplink and downlink data of UE 110, the PGW 150 starts (430) a timer a time length of which is the value of the negotiated RRC release timer for UE 110 included in the received Create Session Request.

PGW 150 then releases/terminates the charging session after the timer expires according to the monitored UE 110 traffic, as illustrated in the procedure 300 shown in FIG. 3.

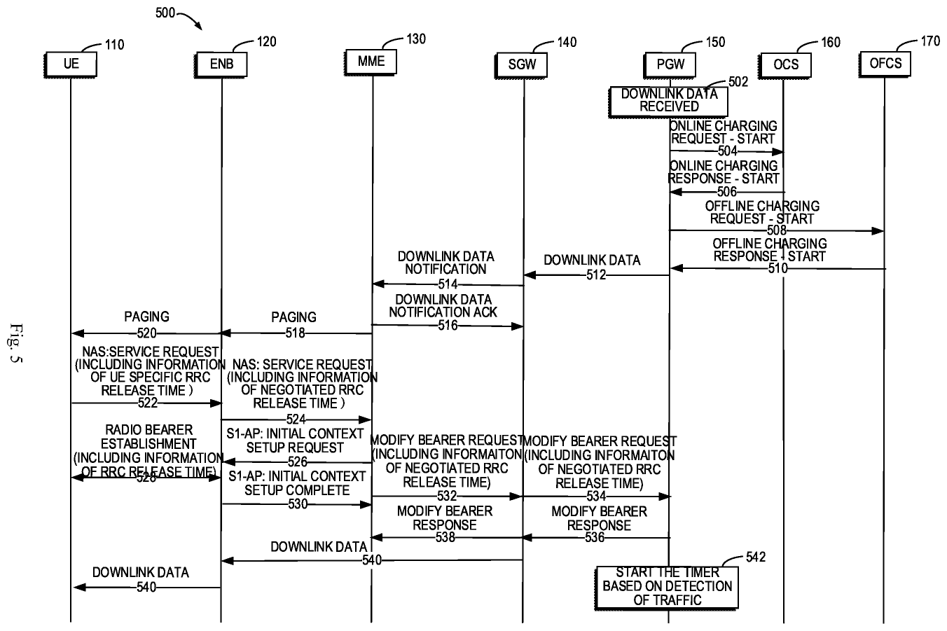

FIG. 5 illustrates a procedure 500 of managing charging session according to another embodiment of the present disclosure. The method 500 shows a scenario where a service request is triggered by the network, for example, the downlink data for UE 110 transmitted from a Packet Data Network (PDN) triggers the service request. It may be appreciated that according to the embodiment of the present disclosure, when UE 110 is in a sleep state, there is no charging session in alive state between PGW 150 and charging system (e.g., OCS 160, OFCS 170).

When downlink data for UE 110 from for example the PDN network is received (502) at PGW 150, PGW 150 transmits (504) an Online Charging Request-Start to OCS 160 and transmits (508) an Offline Charging Request-Start to OFCS 170. Correspondingly, OCS 160 returns (506) an Online Charging Response-Start and OFCS 170 returns (510) an Offline Charging Response-Start, and PGW 150 therefore starts a new Gy online charging session and a new Gz offline charging session.

The downlink data is forwarded (512) from PGW 150 to SGW 140. When SGW receives the downlink data of UE 110 in the sleep state, it transmits (514) a Downlink Data Notification to MME 130, and MME 130 returns (516) a Downlink Data Notification Acknowledgement. If UE 110 is already registered in MME 130 and considered reachable for paging, MME 130 transmits (518) a Paging message. Then eNB 120 pages (520) UE 110.

When UE 110 is in the sleep state, upon reception of paging indication in E-UTRAN access, UE 110 initiates the UE-triggered service request procedure, as procedure 400 described above. That is, UE 110 initiates the service request, and includes information on its RRC release timer in the service request. Subsequently, similar with the procedure 400, UE 110 and eNB 120 establish the radio bearer. After receiving an Initial Context Setup Complete message (including for example the information on the negotiated RRC release time) from eNB 120, MME 130 transmits a Modify Bearer Request to SGW 140. SGW 140 then forwards the Modify Bearer Request to PGW 150, and the Modify Bearer Request for example includes the information on the negotiated RRC release timer. Then, through the already-established bearer, SGW 140 forwards (540) the downlink data received at 512 to eNB 120, and transmits it to UE 110.

On the other hand, PGW 150, in response to receiving the information on the negotiated RRC release timer, detects that the traffic to or from UE 110 is lower than a threshold, for example, there is no uplink and downlink data of UE 110, the PGW 150 starts (542) a timer a time length of which is the value of the negotiated RRC release timer for UE 110 included in the received Create Session Request. PGW 150 then releases/terminates the charging session after the timer is expired according to the monitored UE 110 traffic, as illustrated in the procedure 300 shown in FIG. 3.

It can be seen from the above that the embodiments of the present disclosure avoid the case that the Gy session is in the alive state for a long time period when there is no useful charging activity and enable termination of the charging session between PGW and charging system at a proper time, which saves the monitoring and calculating needs of the PGW and OCS/OFCS system, and substantially optimizes the network resources.

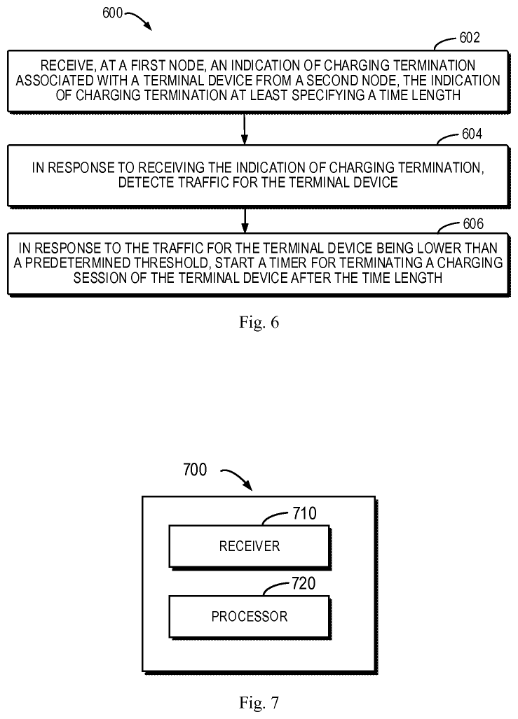

FIG. 6 illustrates a flowchart of a method 600 according to an embodiment of the present disclosure. The method 600 may be performed at an entity having a Policy and Charging Enforcement Function (PCEF), for example, PGW 150 in an embodiment of the present disclosure.

At 602, at a first node, an indication of a charging termination associated with a terminal device specifying at least a time length is received from a second node. For example, in an embodiment, PGW receives an indication of a charging terminal associated with a terminal device from other network nodes such as SGW 140, and the indication of the charging termination at least specifies a time length. The time length for example corresponds to the negotiated RRC release time or timer value as described above, or a time that MME 130 or other network entities specifies the RRC connection to be released designated by will be released.

In an embodiment of the present disclosure, the receiving the indication of the charging termination comprises receiving at least one of the Create Session Request and Modify Bearer Request, namely. The indication may be included in for example the Create Session Request message or the Modify Bearer Request message, and may be carried by any suitable information element.

At 604, traffic for the terminal device is detected in response to receiving the indication of the charging termination. In an embodiment, for example, PGW 150 monitors the traffic for the terminal device, and detects the traffic of the terminal device upon receiving the indication of the charging termination.

At 606, in response to the traffic for the terminal device being lower than a predetermined threshold, a timer is started for terminating the charging session of the terminal device after the time length. In an embodiment, when PGW 150 detects that the traffic of the terminal device is lower than the threshold, for example, there is no traffic for the terminal device, the PGW 150 starts the timer, and may terminate the charging session of the terminal device after the time length specified by the indication of the charging termination. This is because the terminal device is also correspondingly set in the sleep state according to the information of the indication of charging termination. When the terminal device is in the sleep state, PGW 150 correspondingly terminates the corresponding charging session. Hence, the method 600 optimizes charging session management.

In an embodiment of the present disclosure, for example after PGW 150 starts the timer and before the timer expires, a change in traffic for the terminal device is detected. When it is detected that the traffic increases above the predetermined threshold, for example the uplink and downlink data for the terminal device is detected, the timer is stopped to cancel the timing operation.

In another embodiment of the present disclosure, when the traffic of the terminal device is above the predetermined threshold, for example, there exists the uplink and downlink traffic, the traffic of the terminal device is redetected after a predetermined time interval; and when the traffic of the terminal device decreases below the predetermined threshold, for example, there is no further uplink and downlink traffic, the timer is started for terminating the charging session of the terminal device after the time length.

FIG. 7 illustrates an applicable block diagram of an apparatus 700 according to an embodiment of the present disclosure. In an embodiment of the present disclosure, the apparatus 700 may be implemented as an entity with Policy and Charging Enforcement Function (PCEF) such as PGW 150 or a part thereof. The apparatus 700 is operable to execute the method and/or communication procedure described with reference to FIG. 2-FIG. 6, and any other processing and method.

To this end, the apparatus 700 comprises: a receiver 710 configured to receive, from another node of the communication system, an indication of charging termination associated with the terminal device, where the indication of charging termination at least specifies a time length; and a processor 710 configured to detect traffic for the terminal device in response to receiving the indication of charging termination; and in response to the traffic for the terminal device being lower than a predetermined threshold, start the timer for terminating the charging session of the terminal device after the time length.

In an embodiment, the receiver is configured to receive from the second node an indication of release time of a RRC connection.

In an embodiment, the processor is configured to, in response to the traffic of the terminal device being above the predetermined threshold, redetect the traffic of the terminal device after a predetermined time interval; and in response to the traffic of the terminal device decreasing below the predetermined threshold, start the timer for terminating the charging session of the terminal device after the time length.

In an embodiment, the processor is further configured to: in response to the timer having expired, originate a request of charging termination to a charging system of the communication system; and terminate the charging session of the terminal device based on a response to the request of charging termination from the charging system. The receiver is configured to receive the response to the charging termination request from the charging system.

In an embodiment, the processor is further configured to, after the timer is started and before the timer is expired, detect a change in the traffic for the terminal device; and stop the timer in response to detecting that the traffic increases above the predetermined threshold.

In an embodiment, receiving the indication of charging termination comprises receiving at least one of a Create Session Request and a Modify Bearer Request.

In an embodiment, the time length is determined by a negotiation between the terminal device and a base station device in the communication system based on the traffic of the terminal device.

When the apparatus 700 is used to implement PGW 150, the receiver 710 and the processor 720 may operate in cooperation to implement the methods/procedures described in detail with reference to FIG. 2-FIG. 6. It should be understood that each component in apparatus 700 corresponds to each step of the methods and/or communication procedures described with reference to FIG. 2-FIG. 6. Hence, the operations and features described in conjunction with FIG. 2-FIG. 6 are also applicable to the apparatus 700 and components included therein, and have the same effects. Details are not presented any more.

According to the above-mentioned aspects and embodiments, through the control of appropriate indications on RRC connection of the terminal device during the charging session management, it is feasible to terminate the charging session between the Charging Enforcement Function Entity (e.g., PGW) and the charging system (e.g., OCS/OFCS) at a proper time, thus saving the monitoring and calculating demands of the network device, optimizing management of the charging session, and optimizing network resource utilization as well.

Those skilled in the art can readily appreciate that blocks or steps in the above methods may be executed by a programmed computer. In the present disclosure, some embodiments are intended to cover a program storage device, such as a digital data storage medium storing program instructions which are machine or computer-readable and may be executed by an encoding machine or may be executed by a computer, wherein the instructions execute some or all steps of the above methods. The program storage device may be for example a digital memory, a magnetic storage medium such as a magnetic disk or magnetic tape, a hard disk driver or optically-readable digital data storage medium. The embodiments are further intended to cover a computer programmed to execute steps of the above method.

Functions of elements of the apparatus shown in the drawings may be provided by using software, dedicated hardware, and hardware associated with proper software and being capable of executing software, or firmware, or a combination thereof. When they are provided by a processor, the functions may be provided by a single dedicated processor, a single shared processor or a plurality of separate processors. In addition, the term “processor” may include but is not limited to a digital signal processor (DSP) hardware, a network processor, an Application Specific Integrated Circuit (ASIC), a Field Programmable Gate Array (FPGA), a Read Only Memory (ROM) for storing software, Random Access Memory (RAM), and a non-volatile memory. It may further comprise other conventional and/or customized hardware.

Through the above depictions and relevant teaching given in the drawings, many modifications of the present disclosure presented here and other embodiments will be recognized by those skilled in the art. Therefore, it will be appreciated that embodiments of the present disclosure are not limited to the disclosed specific embodiments, and modifications and other embodiments are intended to be included in the scope of the present disclosure. In addition, although the above depictions and drawings describe example embodiments under the background of some exemplary combination forms of parts and/or functions, it should be appreciated that alternative embodiments may provide different combination forms of parts and/or functions without departing from the scope of the present disclosure. At this point, for example, other combination forms of parts and/or functions different from what are clearly described above are also expected to fall within the scope of the present disclosure. Although specific terms are used here, they are only used in general and descriptive sense and not intended to limit.

1. A method of charging session management, comprising:
receiving, at a first node of a communication system, an indication of charging termination associated with a terminal device from a second node of the communication system, the indication of charging termination at least specifying a time length;
in response to receiving the indication of charging termination, detecting traffic for the terminal device; and
in response to the traffic for the terminal device being lower than a predetermined threshold, starting a timer for terminating a charging session of the terminal device after the time length.

2. The method according to claim 1, wherein receiving the indication of charging termination comprises:
receiving an indication of releasing time of a Radio Resource Control (RRC) connection from the second node.

3. The method according to claim 1, further comprising:
in response to the traffic of the terminal device being above the predetermined threshold, redetecting the traffic of the terminal device after a predetermined time interval; and
in response to the traffic of the terminal device decreasing below the predetermined threshold, starting the timer for terminating the charging session of the terminal device after the time length.

4. The method according to claim 1, further comprising:
in response to the timer having expired, originating a request of charging termination to a charging system of the communication system;
receiving a response to the request of charging termination from the charging system; and
terminating the charging session of the terminal device based on the response.

5. The method according to claim 1, further comprising:
after the timer is started and before the timer expires, detecting a change in the traffic for the terminal device; and
in response to detecting that the traffic for the terminal device increases above the predetermined threshold, stopping the timer.

6. The method according to claim 1, wherein receiving the indication of charging termination comprises receiving at least one of a Create Session Request and a Modify Bearer Request.

7. The method according to claim 1, wherein the time length is determined by a negotiation between the terminal device and a base station device in the communication system based on traffic of the terminal device.

8. The method according to claim 1, wherein the first node is a packet data network gateway of the communication system, and the second node is a service gateway of the communication system.

9. A network device in a communication system, comprising:
a receiver configured to receive, from a node of the communication system, an indication of charging termination associated with a terminal device, the indication of charging termination at least specifying a time length;
a processor configured to:
in response to receiving the indication of charging termination, detect traffic for the terminal device; and
in response to the traffic for the terminal device being lower than a predetermined threshold, start a timer for terminating a charging session of the terminal device after the time length.

10. The network device according to claim 9, wherein the receiver is configured to receive from the node an indication of releasing time of a Radio Resource Control (RRC) connection.

11. The network device according to claim 9, wherein the processor is configured to:
in response to the traffic of the terminal device being above the predetermined threshold, redetect the traffic of the terminal device after a predetermined time interval; and
in response to the traffic of the terminal device decreasing below the predetermined threshold, start a timer for terminating the charging session of the terminal device after the time length.

12. The network device according to claim 9, wherein the processor is further configured to:
in response to the timer having expired, originate a request of charging termination to a charging system of the communication system; and
terminate the charging session of the terminal device based on a response to the request of charging termination from the charging system; and
the receiver is configured to receive the response to the request of charging termination from the charging system.

13. The network device according to claim 9, wherein the processor is further configured to:
after the timer is started and before the timer expires, detect a change in the traffic for the terminal device; and
in response to detecting that the traffic for the terminal device increases above the predetermined threshold, stop the timer.

14. The network device according to claim 9, wherein receiving the indication of charging termination comprises receiving at least one of a Create Session Request and a Modify Bearer Request.

15. The network device according to claim 9, wherein the time length is determined by a negotiation between the terminal device and a base station device in the communication system based on traffic of the terminal device.

16. The network device according to claim 9, wherein the network device is a packet data network gateway of the communication system, and the node is a service gateway of the communication system.

17. A computer readable storage medium having computer readable program instructions stored thereon for performing steps of the method according to claim 1.
